(19) United States
(12) Patent Application Publication
(10) Pub. No.: US 2017/0117842 A1
(43) Pub. Date: Apr. 27, 2017

(54) SOLAR MODULE MOUNTING APPARATUS AND METHOD OF MOUNTING THE SAME

(71) Applicant: Robert Grant, Auburn, CA (US)

(72) Inventor: Robert Grant, Auburn, CA (US)

(21) Appl. No.: 15/290,296

(22) Filed: Oct. 11, 2016

Related U.S. Application Data
(60) Provisional application No. 62/244,301, filed on Oct. 21, 2015.

(51) Int. Cl. H02S 20/10; H02S 20/32

(52) U.S. Cl. CPC H02S 20/10; H02S 20/32

(57) ABSTRACT

A system for mounting a solar module of a solar module array is provided. The system has a fixed foundation configured to attach to an underlying surface as a foothold foundation; a slant beam coupled to the fixed foundation and configured as a support for the solar module, and a hat channel coupled to the slant beam in an orthogonal plane, such that the hat channel overlaps an adjacent hat channel to form an single elongated cross beam, wherein a space is provided between the hat channel and the slant beam. A method for mounting a solar cell to a mounting system is also provided.

### CROSS-REFERENCE TO RELATED APPLICATIONS

The present utility patent application claims the priority benefit of the U.S. provisional application for patent Ser. No. 62/244,301 filed on Oct. 21, 2015, entitled A Solar Module Mounting Apparatus and Method of Mounting the Same

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates generally to a solar panel racking system and method, and more particularly to an integrated assembly and mounting system for a plurality of solar panels.

A solar module, which is comprised of photovoltaic cells, is an electrical device that converts the energy of light directly into electricity by the photovoltaic effect. Solar cells are the building blocks of photovoltaic modules, otherwise known as solar panels. On the other hand, solar thermal collector supplies heat by absorbing sunlight, for the purpose of either direct heating or indirect electrical power generation from heat—a “photoelectrolytic cell”.

The solar industry, generally, has experienced explosive growth in over the last five years. As an example, in 2014, the U.S. solar industry in 2014 grew by over 34%, in which nearly 7,000 megawatts (MW) of solar electric capacity were installed. Within the photovoltaic (PV) sector, over 6,200 MW of capacity was installed, led by the residential and utility segments, which grew by 51% and 38%, respectively. Together, the solar industry installed 32% of all new electricity generating capacity in the U.S. This growth has led to congruent and substantial growth in the solar mounting and racking industry as well.

Solar mounting and racking systems must be installed in sun or light exposed area. Most often, it is desirable to mount solar panels outdoors at an angle from the horizontal so that they will more directly face the sun during peak daylight hours, rather than being mounted flat to the ground or another surface. Many times, many solar panels are mounted together to form a solar panel array, which may utilize hundred or even thousands of solar panels. Mounting and racking systems are a critical cost component in any solar field.

Ground mount solar racking systems, generally, have been described in many publications. For example, U.S. Patent Application Publication No. 2007/0133474 to Mascolo et al. describes a supported solar panel assembly comprising a solar panel and solar panel module that supports the module, a module registration member engaging the solar panel module to position the solar panel module on the module support, and a mounting element.

U.S. Pat. No. 9,010,042 to Anderson describes a system and method of mounting and retaining solar panels. The apparatus comprises foundational members embedded in the supporting surface, a support frame configured to receive the solar panel modules, a support strut assembly configured to attach the support frame to the three foundational members to support the solar panel modules, where the support strut assembly includes a plurality of strut members, and includes one or more adjustment mechanisms that may be used to adjust a length or a joining angle of at least one of the strut members.

U.S. Pat. No. 8,881,484 to Zante provides for a long span solar collector mounting system with a deployable truss structure centered beneath the beam, and a single centered vertical support and a stabilizing end support for mounting solar panels and other equipment on roofs and other surfaces, that can be tilted to a desired angle with respect to the ground, and can be rotated about its vertical axis to maximize solar production, with a vertical member that is offset to direct resultant wind loads directly through the base thereby minimizing twisting or bending stresses on roof structures, with beam clamping capability for attaching to roof beams below the roof with only access above the roof, that can be tilted during and after installation for reroofing and servicing access, with angled retaining nuts that provide secure attachment of solar panels and other equipment.

However, past approaches are unduly expensive and can be difficult and costly to assemble due to the cost of raw materials (e.g. steel) and the excess of parts or elements employed in their construction.

Accordingly, the present system, apparatus and method is directed towards overcoming these aforementioned problems, while setting forth a solar mounting and racking system that is eliminates excessive raw materials while still complying with engineering specifications and reducing cost.

### BRIEF DESCRIPTION OF THE DRAWINGS

FIG. 1a is a side view of the solar rack accordance with an embodiment of the present invention;

FIG. 1b is a side view of the solar rack accordance with an embodiment of the present invention;

FIG. 2 is a perspective view of cross beam hat channels in accordance with embodiments of the present invention;

FIG. 3 is a side view of the solar rack and foundation accordance with an embodiment of the present invention;

FIG. 4 is a perspective view of the solar rack and foundation accordance with an embodiment of the present invention;

FIG. 5 is a perspective view of the solar rack channels in accordance with an embodiment of the present invention;

FIG. 6 is a perspective view of the solar rack of the preceding Figures having a cell mounted thereon in accordance with an embodiment of the present invention;

FIG. 7 is a stepwise flowchart for a method of assembling a solar mount in accordance with the present invention.

### SUMMARY OF THE INVENTION

The following summary of the invention is provided in order to provide a basic understanding of some aspects and features of the invention. This summary is not an extensive overview of the invention and as such it not intended to particularly identify key or critical elements of the invention or to delineate the scope of the invention. Its sole purpose is to present some concepts of the invention in a simplified form as a prelude to the more detailed description that is presented below.

In exemplary embodiments, a system for mounting a solar module of a solar module array, the system having a fixed foundation configured to attach to an underlying surface as a foothold foundation is provided and comprises a slant beam coupled to the fixed foundation and configured as a support for the solar module; a hat channel coupled to the slant beam in an orthogonal plane, such that the hat channel overlaps an adjacent hat channel to form an single elongated cross beam, wherein a space is provided between the hat channel and the slant beam.

In exemplary embodiments, an installed and mounted solar module system is provided comprising a fixed foundation configured to attach to an underlying surface as a foothold foundation; a slant beam coupled to the fixed foundation and configured as a support for the solar module; a hat channel coupled to the slant beam in an orthogonal plane, such that the hat channel overlaps an adjacent hat channel to form an single elongated cross beam, wherein a space is provided between the hat channel and the slant beam and a solar module mounted to the hat channel.

In exemplary embodiments, a method of assembling a mount assembly for a solar module is provided. The method comprises fixing foundation to a surface, attaching slant beam to the foundation at an upper end of the foundation; attaching a hat channel to the slant in a horizontal direction such that the hat channel overlaps an adjacent hat channel, wherein the hat channel is configured to connect the at least one cross beam and the adjacent cross beam to form an single elongated cross beam, and wherein a space is provided between the hat beam and the slant beam for cooling.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there is illustrated the preferred embodiment and best mode of practicing the invention.

Other features, advantages, and aspects of the present invention will become more apparent and be more readily understood from the following detailed description, which should be read in conjunction with the accompanying drawings.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. For example, while photovoltaic cells are primarily referred to herein, it will be appreciated that other components are applicable to embodiments of the present invention. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

In the description set forth below, a fixed tilt solar mounting system is described in the context of being formed by a plurality of solar collection modules. Each of the modules can include a support member supporting a plurality of solar collection devices as well as wiring for connecting the various solar collection devices to each other and to other modules. The system can also include devices for reducing labor, hardware, or other costs associated with installing such a system. For example, the collection system or the modules included in such a system can be supported above the ground with bearing assemblies that include one or more various features designed to accommodate misalignments that may result during the installation of mounting piles. Further, the modules can include other features for simplifying the manufacture of such modules and the arrangement and installation of such modules at an installation site.

“Hat channel”, as used herein, refers to a furring channel that has a hat-shaped component used traditionally in drywall to furr out masonry walls and ceiling assemblies. They are typically fabricated in ½″, ⅞″, 1½″ depth, from 25 gauge to 14 gauge steel having a length of 12′-0″-20′-0″, but longer and shorter length hat channels are contemplated herein. They are typically formed from galvanized steel or aluminum. Hat channels are comprised of two horizontal outward flanges, referred to as “the brim” and two vertical dimensions having a top, referred to herein as “the crown”. Hat channels may also be described as a roll formed metal U-channels with a bottom horizontal web and two vertical legs with outward flanges. These outward flanges can also be called wings or fins.

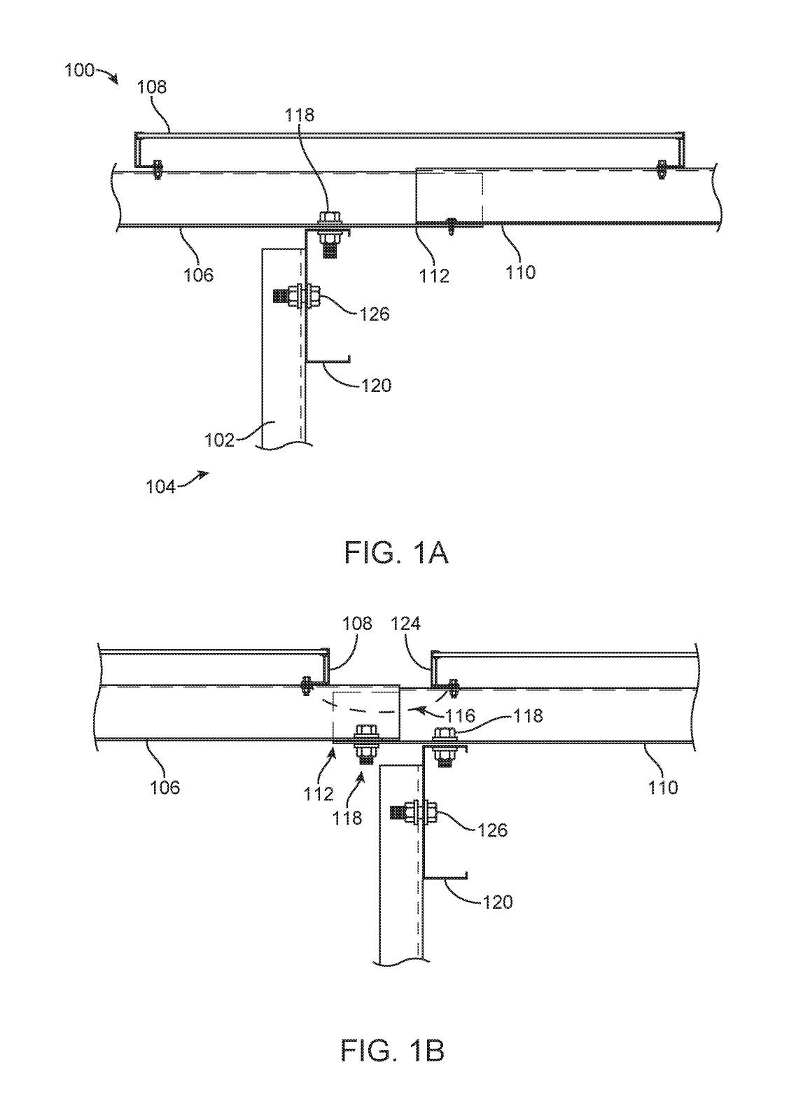

Referring now to FIG. 1A, an apparatus and system for mounting a solar module of a solar module array is shown generally at 100. The system may comprise a fixed foundation 102 which is set in a ground 104, slant beam 120, a first hat channel 106, and solar module 108, and a second hat channel 110. The solar active component or module 108 is preferably mounted via the mounting assembly on a support having a mounting surface, whereby its solar active face is orthogonal to the ground/horizon. The solar active component is further preferably mounted at or near its perimeter frame or edge, wherein its perimeter frame or edge is adjacent the support.

The fixed foundation or foundation 102 acts as a foothold, and may be secured to the ground via concrete, cement, and the like. In optional embodiments, bracketing systems (not shown) may be used to ensure further stability. In exemplary embodiments, the foundation 102 is underground at least twelve inches, preferably 7 to 9 feet, and is formed of steel, aluminum, and other metals, alloys or plastics, and derivatives thereof, that have the strength and capability to firmly secure the module to the ground or underlying surface 104.

In operation, the foundation 102 may be, under appropriate circumstances and considering issues as design preference, user preferences, applications, marketing preferences, cost, structural requirements, available materials, technological advances, etc., be mounted to any suitable structure including an above ground exposed surfaces such as buildings, rooftops, bridges, and the like. In this embodiment, described herein, the foundation is mounted to ground and encased in cement or like substance. Pole mounts, which are driven directly into the ground or embedded in concrete. Foundation mounts, such as concrete slabs or poured footings. Ballasted footing mounts, such as concrete or steel bases that use weight to secure the solar module system in position and do not require ground penetration. This type of mounting system is well suited for sites where excavation is not possible such as capped landfills and simplifies decommissioning or relocation of solar module systems.

Referring still to FIG. 1A, a slant beam 120 is fixed to the foundation 102 at connection point 126. As shown, in this embodiment, an end of the foundation 102 is attached to a slant beam 120, which is configured to provide an angle or gradient to the solar cells mounted to the hat channel 106. The slant beam 120, in turn, is connected to the first hat channel 106 on each side brim of the hat channel 106. In this way, an enlarged connection or mating surface with the hat channel 106, which in turn, provides greater connection point stability. Connection member 118 is configured to fix the slant beam 120 to the hat channel 106 and may comprise a screw and nut arrangement which mates with apertures in the brim of the hat channel 106 and apertures in the slant beam 120, but in optional embodiments, may be any type of fastener such as rivets and joints, but may also comprise other means of fixing such as crimping, welding, soldering, brazing, taping, gluing, cementing, or the use of other adhesives. The use of force may also be used, such as with magnets, vacuum (like suction cups), or friction fits.

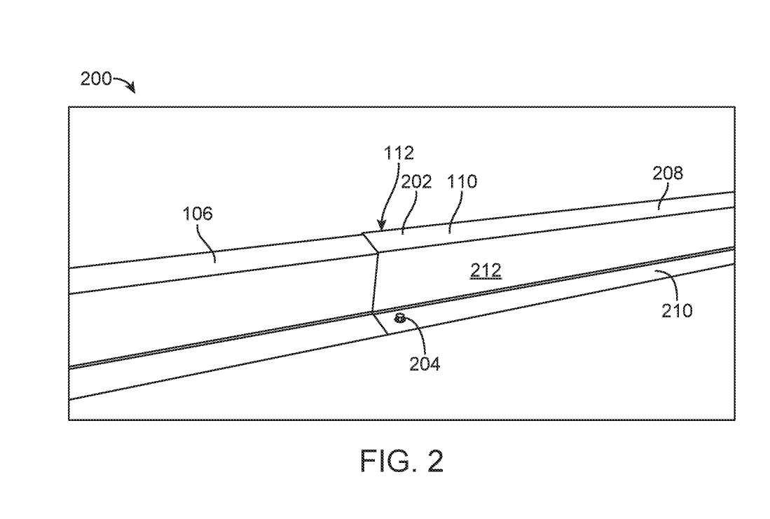

The system further comprises a second hat channel 110 which is interposed or overlapping with the first hat channel 106 at overlap region 112. In this way, overlap region 112 provides additional strength and stability, and the ability to connect a plurality of hat channels (n+1) disposed in a plurality of horizontal rows many kilometers long, where needed. This connection point and overlap will be described in greater detail with relation to FIG. 2.

The hat channels 106 and 110 further comprise connection elements provided to connect photovoltaics 108 to the mounting system. The photovoltaics may have their own casing and attachment means to connect to the hat channels 106 and 110. In embodiments of the present invention, the solar module 108 is attached to the crown of the hat channels 106 and 110. The crown of the hat channels 106 and 108 may be formed with a plurality of apertures configured to accept connection elements which will meet the hat channels 106 and 110 to the solar module 108.

Referring now to FIG. 1B, the same view of FIG. 1A is shown, except at a different section of the system, and a dynamic joint condition is shown herein in which two separate solar modules and the connection points are shown. As referred to herein, a “dynamic joint condition” allows for movement in the horizontal plane to allow for thermal expansion and contraction.”

For purposes of spatial reference, hat channel 106, hat channel 110, overlap region 112, solar module 108, and an additional solar module 124 are shown.

To safely connect solar modules, the system may further comprise an electrical bonding jumper 116 attached to expansion joint 118 and coupled to the connection point at which the solar cells are attached to the crown of the hat channel. Because of the mechanical splice between the hat channels, it is then necessary to also make an electrical splice, which the bonding jumper is configured to provide. In embodiments of the present invention, the bonding jumper 116 may be manufactured from stainless steel with viritium plating resist galvanic corrosion.

The system may further comprise a pivot bolt 126 disposed through the foundation 102. The pivot bolt is configured to provide a range of motion to the slant beam 120 such that an operator can angle the solar modules 108 to an optimal angle to ensure maximum exposure and electrical output. The pivot bolt 126 may comprise a bolt and nut arrangement as is known in the art. In optional embodiments a servo motor maybe electrically connected to a piston or gear arrangement to change the tilt angle of the solar modules, either in automated fashion based on sensor input from solar radiation, or manually by an operator. In this way, the system minimizes the angle of incidence between the incoming sunlight and a photovoltaic panel. This increases the amount of energy produced from a fixed amount of installed power generating capacity. As an example, axes of rotation may typically aligned either along a true north meridian or an east-west line of latitude.

Adjustability may occur via a controller which may be in communication with a computer processor at a main workstation such that an operator may adjust the tilt angle according to the component specifications. CPU may be comprised of a single processor or multiple processors and may be of various types including micro-controllers (e.g., with embedded RAM/ROM) and microprocessors such as programmable devices (e.g., RISC or CISC based, or CPLDs and FPGAs) and devices not capable of being programmed such as gate array ASICs (Application Specific Integrated Circuits) or general purpose microprocessors.

In optional embodiments, the CPU optionally may be coupled to network interface which enables communication with an external device such as a database or a computer or telecommunications or internet network using an external connection which may be implemented as a hardwired or wireless communications link using suitable conventional technologies. Communications via remote connectivity include, but are not limited to the Internet, Satellite networks, Cell Phone networks, other wireless networks and standards such as 802.11, 80211.b, 802.11g, or similar wireless LAN or WAN operating standards, or Bluetooth technologies, infrared connections, or any other similar technologies or other technologies such as those described above that permit the sending and/or receiving and/or processing of electronic information in either an encrypted or unencrypted format. At a the CPU or Programmable Logic Controller (PLC) (e.g., operator workstation) the operator may control all aspects of the processes adjusting the angle of the panels.

Referring now to FIG. 2, a perspective view of the hat channels overlapping and connected together is shown generally at 200. For purposes of spatial orientation, the first hat channel 106 and the second hat channel 110 are shown. It should be noted however, that any hat channel in the system may have a similar connection. The overlap of hat channel 106 and hat channel 108 is shown at reference 112, the overlap forming overlap section 202. its brim. The crown 208 and the brim to 210 of the hat channels are shown herein for reference, together with the side of the hat channel 212. The hat channels may be connected by 204, which in some embodiments may comprise a tek screw or a self-tapping screw is a screw that is capable of tapping its own hole as it is driven into the substrate, by cutting a gap in the continuity of the thread on the screw, generating a flute and cutting edge similar to those on a tap. In this way, the overlap section 112 or 202 is configured to securely connect the at channel 106 and the hat channel 110. The connection strength is provided at the overlapping region 212 such that weather and seismic conditions do not destroy the structure and the structure is able to withstand these shifts. Furthermore, the connector element is positioned at a central axis of the aperture, and is configured to allow movement due to thermal expansion and contraction.

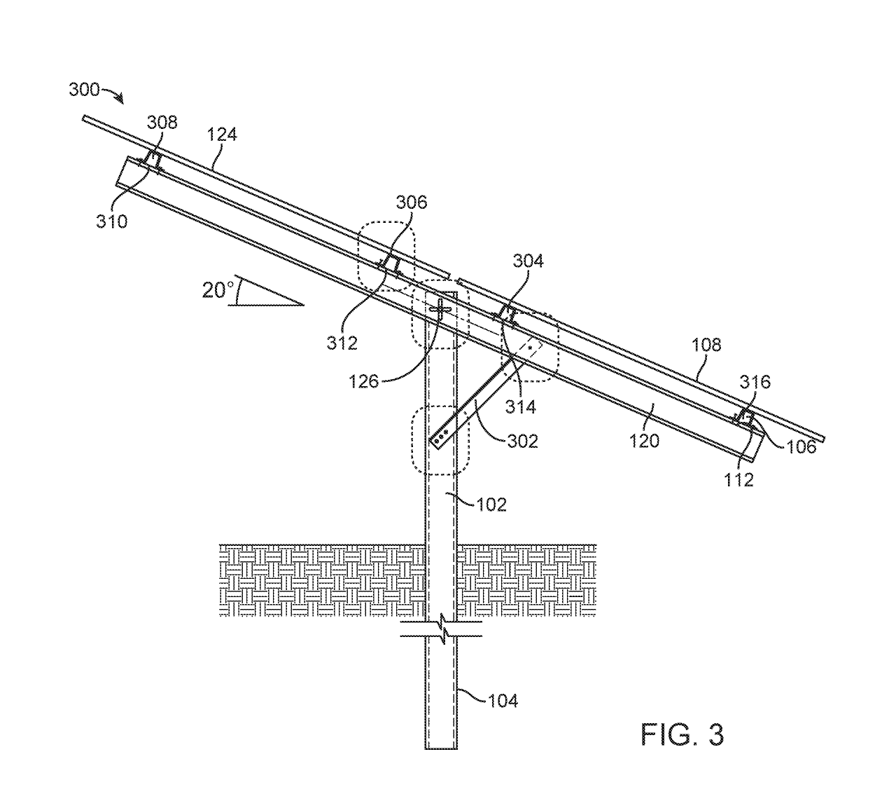

Referring now to FIG. 3, a side view of the solar rack and foundation accordance with an embodiment of the present invention is shown generally at 300. As shown in FIGS. 1 and 2, the system may comprise a fixed foundation or foundation 102 for ground 104, a first hat purlin 106, and solar module 108, slant beam 120, and pivot bolt 126, all of which are shown for purposes of orientation. It should be noted that second hat channel 110 cannot be seen as it is directly behind channel 106 when viewed from the side.

In an embodiment of the present invention, the system may further comprise brace 302, which is connected to the foundation 102 and the slant beam 120. The brace 302 forms an approximate right angle at its connection point with the slant beam 120 so as to provide additional stability and ensure the tilt angle of the solar modules 108 and 124 stay at the optimal tilt in case of high wind. Like the other connection points in the system, the brace may be held by any known connection element suitable for its purpose.

Slant beam 120 may comprise a plurality of connection points to connect to a plurality of hat channels. As shown each solar module 108 and 124 are connected to the slant beam 120 by a pair of hat channels. In this FIG. 3, hat channels 106, 304, 306 and 308 are shown, each having connection points 310, 312, 314, and 112 on the slant beam 120. Each connection point may comprise a nut and screw configuration or any other connection elements that are known in the art and function to serve the desired purpose. A space 316 is provided under the crown for cooling purposes.

Furthermore, while only to solar modules 108 and 124 are shown connected to a single slant beam, any number of the solar modules may be connected to the slant beam 120 depending upon the desired length of the slant beam 120. The slant being 120 and the solar modules may be at an approximately 20° tilt, but other optimum tils angles may be employed.

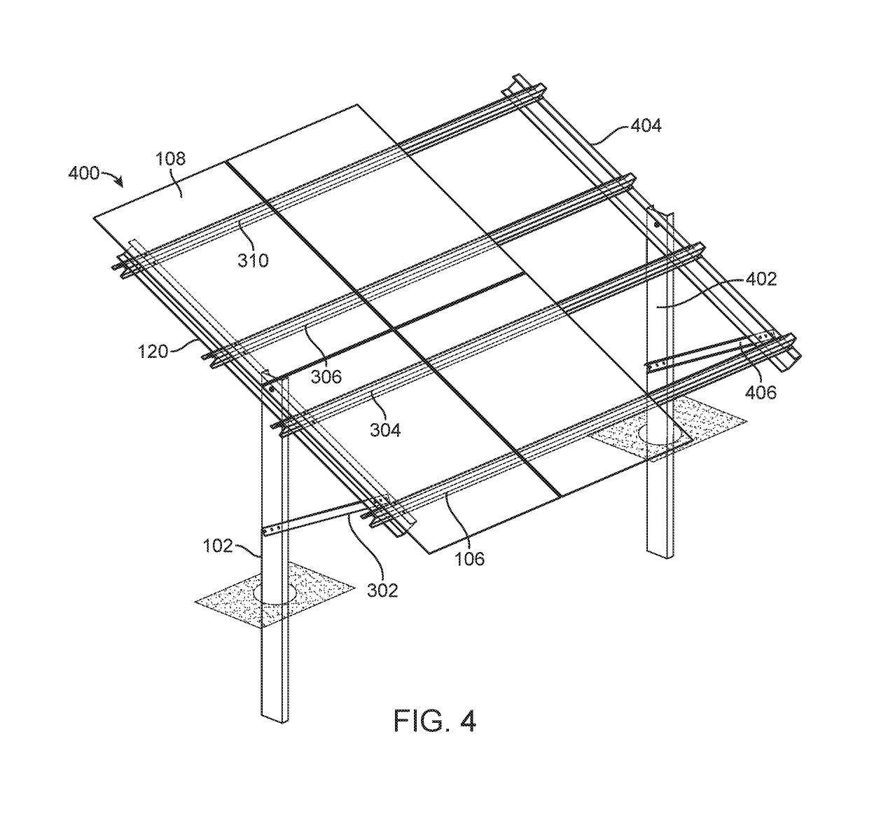

Referring now to FIG. 4, a perspective view of the mounting system of the present invention is shown generally at 400, and shows the scalability of the system from a lateral perspective.

As shown, the foundation 102 and slant beam 120 are the first “paneling system” of the structure. The hat channels 106, 304, 306 and 310 are shown running vertically up the slant beam 120. A second foundation 402 is shown together with a second slant beam 404 which is attached in a similar manner as foundation 102 and slant beam 120. An additional brace 406 is shown as well. In this way the system is modulated such that many modules may be attached in series as needed, easily and inexpensively.

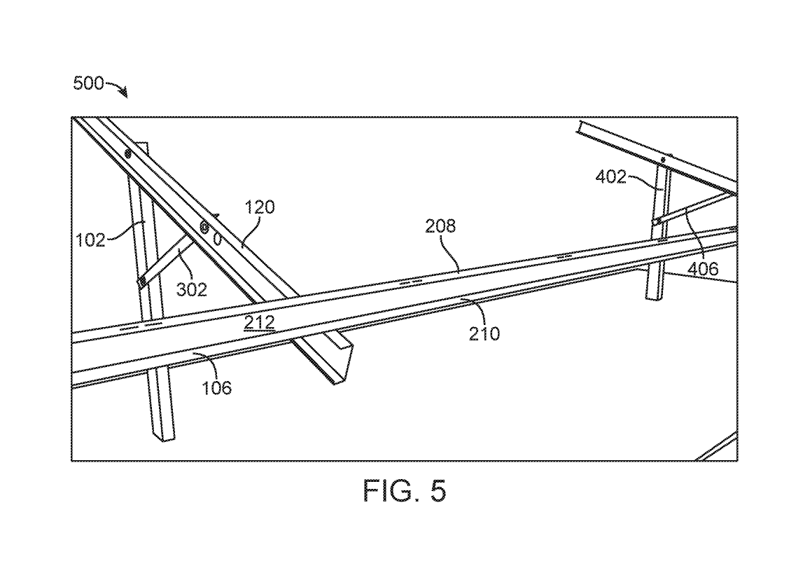

With reference now to FIG. 5, a perspective view of how the hat channels connect to be slant beam is shown generally at 500. The slant beams 120 may be formed in a similar manner as steel stud. The slant beam 120 is attached to the brim portion 210 of the hat channel 106, the crown 208 of the hat channel 106 such that it is exposed and ready to meet with a solar cell.

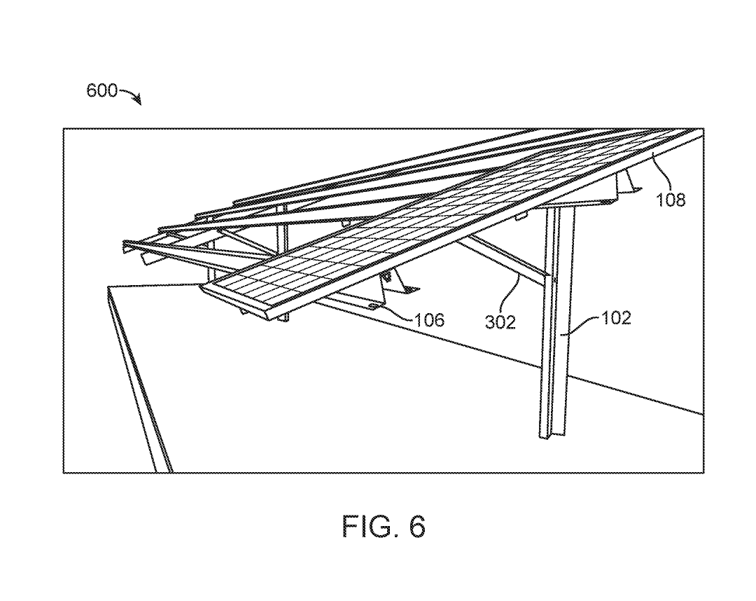

With reference to FIG. 6, the solar cell is shown mated to the mounting module and a perspective view generally at reference 600.

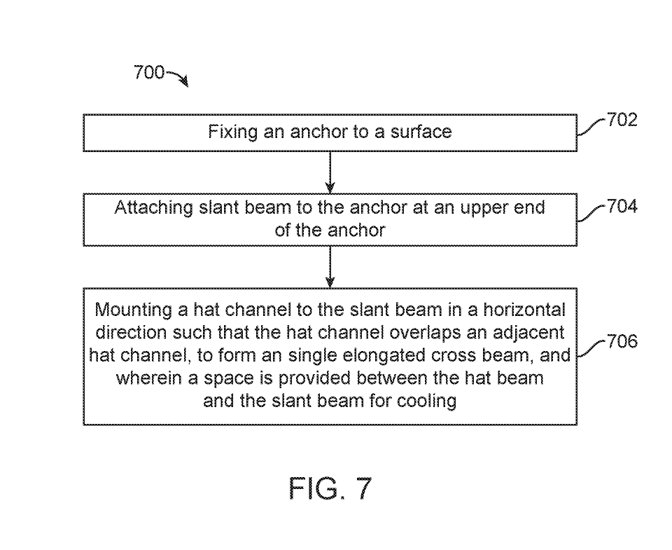

With reference to FIG. 7, a step-wise flow chart is shown at generally at 700. The method for assembling a mounting assembly for a solar module comprises step 702, fixing an foundation to a surface; step 704, attaching slant beam to the foundation at an upper end of the foundation; mounting a attaching a hat channel to the slant beam in a horizontal direction such that the hat channel overlaps an adjacent hat channel, to form an single elongated cross beam, and wherein a space is provided between the hat beam and the slant beam for cooling step 706.

Specific configurations and arrangements of the invention, discussed above with reference to the accompanying drawing, are for illustrative purposes only. Other configurations and arrangements that are within the purview of a skilled artisan can be made, used, or sold without departing from the spirit and scope of the invention. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

What is claimed is:

1. A system for mounting a solar module of a solar module array, the system having a fixed foundation configured to attach to an underlying surface as a foothold, the system comprising:
a slant beam coupled to the fixed foundation and configured as a support for the solar module;
a hat channel coupled to the slant beam such that the hat channel overlaps an adjacent hat channel to form an elongated cross beam, wherein a space is provided between the hat channel and the slant beam.

2. The system of claim 1, wherein the overlap comprises a self-tapping connector configured to connect the plurality of hat channels.

3. The system of claim of claim 1, further comprising a bonding jumper attached to the hat channel and the adjacent hat channel to form an electrical splice, and further configured to maintain a continuous bonding path along the array.

4. The system of claim 1, wherein the hat channels comprise a crown and a brim portion, and the solar module is mounted to the crown of the hat channel and the brim portion is mounted to the slant beam, wherein the space provides between the crown and the slant beam is configured to for cooling.

5. The system of claim 1, wherein the slant beam and the hat channel comprise are configured to provide a predetermined degree of freedom to allow for expansion due to heat or harsh ambient condition.

6. The system of claim 1, further comprising a brace attached to the slant beam at one end, and the foundation at the other end, the brace configured to provide support of the slant beam at a predetermined angle.

7. The system of claim 2, wherein the overlap comprises an expansion slot, wherein the expansion slot is dimensioned to bias the hat channel and the adjacent hat channel such that the hat channel and the adjacent hat channel are overlapping, the expansion slot element providing a predetermined range of motion.

8. The system of claim 7, wherein the overlap is positioned at a central axis of the expansion slots, the expansion slot being configured to allow movement due to thermal expansion and contraction.

9. The system of claim 7, wherein overlap further comprises unslotted brim portion.

10. The system of claim 1, further comprising a pivot bolt disposed through the foundation and the slant beam and configured to provide a range of motion to the slant beam.

11. The system of claim 1, wherein the pivot bolt is connected to a controller and a servo motor to actuate and move the tilt of the slant beam to minimizes an angle of incidence between incoming sunlight and the solar panel.

12. An installed and mounted solar module system, the installed and mounted system comprising:
a fixed foundation configured to attach to an underlying surface as a foothold foundation;
a slant beam coupled to the fixed foundation and configured as a support for the solar module;
a hat channel coupled to the slant beam such that the hat channel overlaps an adjacent hat channel to form an single elongated cross beam, wherein a space is provided between the hat channel and the slant beam;
a solar module mounted to the hat channel.

13. The mounted solar system of claim 12, wherein the overlap is configured to connect at the plurality of hat channels.

14. The mounted solar system of claim 12, further comprising a bonding jumper attached to the hat channel and the adjacent hat channel to form an electrical splice, and further configured to maintain a continuous bonding path along the array.

15. The mounted solar system of claim 12, wherein the hat channels comprise a crown and a brim portion, and the solar module is mounted to the crown of the hat channel and the brim portion is mounted to the slant beam, wherein the space provides between the crown and the slant beam is configured to for cooling.

16. The mounted solar system of claim 12, wherein the slant beam and the hat channel comprise a self-tapping connector to provide a predetermined degree of freedom to allow for expansion due to heat or harsh ambient condition.

17. The mounted solar system of claim 12, further comprising a brace attached to the slant beam at one end, and the foundation at the other end, the brace configured to provide support of the slant beam at a predetermined angle.

18. The mounted solar system of claim 13, wherein the overlap comprises an expansion slot, wherein the expansion slot is dimensioned to bias the hat channel and the adjacent hat channel such that the hat channel and the adjacent hat channel are overlapping, the expansion slot element providing a predetermined range of motion.

19. A method of assembling a mounting assembly for a solar module, the method comprising:
fixing foundation to a surface;
attaching slant beam to the foundation at an upper end of the foundation;
attaching a hat channel to the slant in a horizontal direction such that the hat channel overlaps an adjacent hat channel, wherein the hat channel is configured to connect the at least one cross beam and the adjacent cross beam to form an single elongated cross beam, and wherein a space is provided between the hat beam and the slant beam for cooling.

20. The method of claim 19, further comprising mounting a solar module to the hat channel.
